(19) United States
(12) Patent Application Publication
(10) Pub. No.: US 2020/0218815 A1
(43) Pub. Date: Jul. 9, 2020

(54) SYSTEMS AND METHODS FOR DISTRIBUTED LEDGER MANAGEMENT

(71) Applicant: Comcast Cable Communications, LLC, Philadelphia, PA (US)

(72) Inventors: Asad Haque, Chesterbrook, PA (US); Bahar Limaye, Leesburg, VA (US); Alex Lopatnikov, Herndon, VA (US); Alex Totheroh, Bend, OR (US)

(21) Appl. No.: 16/240,550

(22) Filed: Jan. 4, 2019

(51) Int. Cl. G06F 21/62; G06F 21/44; G06F 16/182; H04L 9/06; H04L 9/32; H04L 9/08

(52) U.S. Cl. CPC G06F 21/62; G06F 21/44; G06F 16/1824; H04L 2209/38; H04L 9/3247; H04L 9/0825; H04L 9/0643

(57) ABSTRACT

Methods and systems are described for managing a distributed ledger. A user may manage permissions and other settings for devices associated with an account by adding transactions to the distributed ledger. Versions of the distributed ledger may be stored by the devices. A master version of the distributed ledger may be managed by a ledger node configured to add data blocks to the master version of the ledger. A consensus process may be used to determine an approved version of the distributed ledger if a condition, such as an error condition or an inconsistency, is detected for the distributed ledger.

### BACKGROUND

A distributed ledger may be used to maintain a linked list of information. The distributed ledger may be susceptible to malicious attacks to make unauthorized changes to the distributed ledger. Conventional distributed ledgers may also require too much resources, such as processing power and storage, to be implemented by devices with resource constraints. Thus, there is a need for more sophisticated approaches for managing distributed ledgers.

### SUMMARY

Systems and methods are described for managing a distributed ledger. A plurality of devices associated with an account may be managed using the distributed ledger. The plurality of devices may store versions (e.g., full or partial versions) of the distributed ledger. A master version of the distributed ledger may be managed by a ledger device, or a plurality of ledger nodes implemented via a network computing service (e.g., a cloud computing service, a group of computing nodes accessible via a network). The ledger device may process requests to read and write data to the distributed ledger. The ledger device may check distributed ledger to determine any conditions, such as an error condition, a validation failure, an inconsistency in hash information, or an inconsistency in comparison to stored validation information. The ledger device may check the distributed ledger based on receiving a request (e.g., in response to, after). The ledger device or device sending the request may notify a consensus device of the condition and cause a consensus process to be performed. The consensus device may retrieve and validate copies of the distributed ledger from the plurality of devices. An approved version of the ledger may be determined by selecting a validated ledger that satisfies one or more conditions checked in the consensus process. The plurality of devices may be notified of the approved version of the ledger.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The following drawings show generally, by way of example, but not by way of limitation, various examples discussed in the present disclosure. In the drawings:

FIG. 1 shows an example block diagram of a distributed system architecture.

FIG. 2 shows an example block diagram of a network ledger.

FIG. 3 shows example sequences for editing a master ledger.

FIG. 4 shows an example communication sequence between devices.

FIG. 5 shows an example communication sequence between devices.

FIG. 6 shows an example communication sequence between devices.

FIG. 7 shows an example communication sequence between devices.

FIG. 8 is a flow diagram of an example method.

FIG. 9 is a flow diagram of an example method.

FIG. 10 is a flow diagram of an example method.

FIG. 11 shows an example computing environment.

### DETAILED DESCRIPTION

Systems and methods are described for managing a distributed ledger. The distributed ledger may be used for managing permissions and other settings at a premises. The distributed ledger may comprise a plurality of versions of the distributed ledger stored at different locations and/or stored by different devices. The distributed ledger may comprise a master ledger and one or more device ledgers. The master ledger may be a version of a distributed ledger stored by a network service. The one or more device ledgers may be versions of the distributed ledger that are stored by one or more premises device, such as Internet of Things (IoT) devices, security devices, automation devices, and/or the like. The master ledger may be used as a master version of the distributed ledger for adding data blocks to the distributed ledger. The master ledger may be stored in a network location external to premises at which device ledgers are located. If a data block is added to the master ledger, any corresponding device ledger may be updated by retrieving a new copy of the master ledger or by adding any additional data blocks added to the master ledger.

Using the master ledger may allow for the network service to implement distributed ledgers for a plurality of users as part of a service, such as a content service, a premises management service, and/or the like. A plurality of master ledgers may be stored for users as part of the network service. The plurality of master ledgers may be stored in a network ledger (e.g., managed and/or stored by the network service). The network ledger may comprise data blocks for a plurality of master ledgers associated with different accounts. The data blocks associated with a specific account stored in the network ledger may be a master ledger for the specific account.

The plurality of master ledgers may be associated with corresponding accounts. A corresponding account may be an account associated with a specific master ledger (e.g., or a distributed ledger including the master ledger and one or more device ledgers). A master ledger associated with an account may be generated for usage by a user associated with the account. The plurality of master ledgers may be managed by a plurality of ledger nodes (e.g., mining nodes, etc.). The plurality of ledger nodes may be implemented by a network computing service (e.g., cloud computing service). The plurality of ledger nodes may manage the plurality of master ledgers. Managing a master ledger may comprise adding data blocks to the master ledger, processing requests to read data blocks from master ledger, validation of the master ledger, and/or the like. Devices associated with an account may send requests to the plurality of ledger nodes to add transactions to the master ledger. The transactions may allow users to manage permissions and other settings without requiring a traditional centralized authorization service to manage devices associated with an account.

The distributed ledgers as disclosed herein (e.g., with a master ledger, device ledgers) may configure premises devices to store versions of the distributed ledger that are limited in size and/or complexity. The distributed ledger may have data blocks that are limited in size and/or the number of transactions in a data block. Using the plurality of nodes to generate new data blocks (e.g., instead of the premises devices) may configure the premises devices to conserve power and processing resources. Premises devices may be used that do not have the capacity to generate new data blocks.

The distributed ledger disclosed herein may be configured to store transactions for an account associated with the distributed ledger. The transactions may related to permission and other settings of premises devices. If a computing device (e.g., user device, premises device, IoT device) makes an adjustment to a setting the computing device may create data (e.g., a record or transaction) indicative of the adjustment and transmit the data to the plurality of ledger nodes (e.g., or a device managing the plurality ledger nodes). An adjustment to a setting may comprise designating a user and/or device as authorized for a premises device, designating a user and/or device as not authorized for a premises device, designating a user and/or device as authorized for a premises device for a time period, designating a user and/or device as authorized for a premises device for limited purposes, etc.

The network service (e.g., and use of master ledgers) may allow users to implement a distributed ledger on premises devices (e.g., IoT devices) that might have constraints, such as power constraints or processing constraints. The premises devices may not comprise the time and/or computational resource requirements of conventional consensus processes required for a single, monolithic ledger. These constraints may cause difficulty in using the distributed ledger to store data associated with the premises. It may be difficult to maintain consistency in the data stored in the plurality of versions of the distributed ledger. Malicious users may try to alter the data on the distributed ledger to gain unauthorized access.

A non-conventional consensus process may be implemented as described further herein. The consensus process may not be based on a known value or leader selection as is suitable for a single, monolithic ledger. The consensus process may be triggered based on a request to process (e.g., add data, read data) a master ledger. A ledger node may receive a request from a computing device. The ledger node may determine that the distributed ledger has a condition, such an error condition or a validation failure. The ledger node may determine based on receiving the request (e.g., in response to receiving, after receiving) that the distributed ledger has the condition. The ledger node may send a message indicating the condition to the computing device. The computing device may transmit a consensus process initiation signal to a consensus device. The computing device may transmit the consensus process initiation signal based on (e.g., in response to) the message indicating the condition. The condition may be indicative of tampering, such as an unauthorized data modification. The unauthorized data modification may comprise one or more of a block deletion, a block addition, and/or tampering with a block. The consensus device may initiate a consensus process. The consensus device may initiate a consensus process based on receiving (e.g., in response to receiving, or after receiving) receiving the consensus process initiation signal. The consensus process may be referred to herein as a sweeper protocol.

As part of the consensus process, the consensus device may request versions of the distributed ledgers from some or all of the devices (e.g., premises devices, user devices, IoT devices) associated with an account. The consensus device may wait for a response from a threshold number of the premises devices or for a predetermined time period. If the consensus device receives copies of the versions of the distributed ledger from the threshold number of premises devices or the predetermined time period expires, then the consensus device may determine an approved version of the distributed ledger. The consensus device may send an indication of the approved version of the distributed ledger to the premises devices.

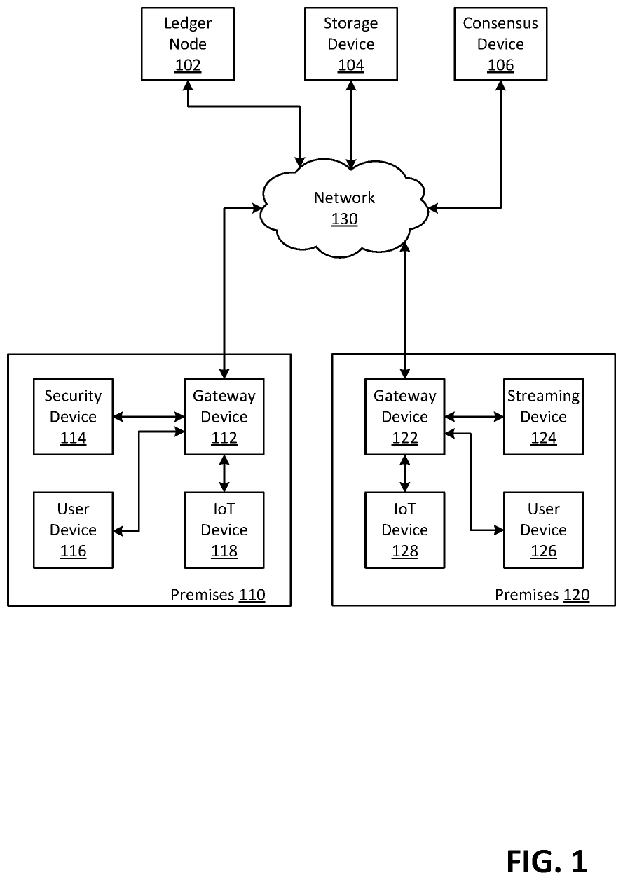

FIG. 1 shows an example block diagram of a distributed system architecture. The distributed system architecture may be configured to enable a user to manage devices associated with an account, such as devices located a premises, using a decentralized approach. The distributed system architecture may comprise one or more ledger nodes 102, a storage device 104, a consensus device 106, one or more premises 110, 120, and a network 130. The distributed system architecture may be configured to use a distributed ledger comprising a plurality of versions (e.g., or copies) of a ledger stored on different devices. The distributed ledger may be based on blockchain. A master ledger may be stored at the storage device 104. The master ledger may comprise a master version of the distributed ledger. Individual devices associated with an account may also store corresponding device ledgers. A device ledger may comprise a version of the distributed ledger stored at a corresponding device. A device ledger may comprise a partial ledger (e.g., less than all of the data blocks of the master ledger) until a sync event occurs. If a sync event occurs, the device ledger may comprise full copy of the master ledger. A sync event may comprise sending a one or more blocks of the master ledger (e.g., or a full copy of the master ledger) to a device storing the device ledger. The one or more ledger nodes 102 may manage the distributed ledger by processing requests to read and/or add data to the distributed ledger. The consensus device 106 may be configured to resolve conditions, such as error conditions, validation failures, or disagreement between versions of the distributed ledger, by using a consensus process to determine an approved version of the distributed ledger.

The one or more ledger nodes 102 may be configured to process requests for a network computing service. The one or more ledger nodes 102 may comprise one or more computing devices. The one or more ledger nodes 102 may be computing devices associated with a network computing service. The one or more ledger nodes 102 may be associated with specific pools of devices, specific accounts, and/or the like. The one or more ledger nodes 102 (e.g., the network computing service) may comprise a plurality of computing instances (e.g., virtual machines) executed by one or more computing devices. A computing instance may comprise an operating system executing a ledger process, such as a server (e.g., or data miner) configured to implement the ledger process. The plurality of ledger nodes 102 may each be configured as a separate computing node that implements the ledger process. Requests associated with the ledger process may be load balanced by distributing the requests among the separate computing nodes (e.g., or virtual machines, data miners, servers). Requests may be received by the network computing service via an application programming interface associated with accessing the network computing service. The one or more ledger nodes 102 may be managed by an entity that leases computing capacity (e.g., virtual machines) as part of the network computing service.

The storage device 104 may comprise one or more master ledgers (e.g., master versions of a distributed ledger). The one or more master ledgers may comprise master ledgers associated with one or more corresponding accounts. The one or more accounts may comprise a user account, such as a subscriber account. The one or more accounts may be created based on a user signing up for a service, such as a communication service (e.g., network access, cellular service), streaming service (e.g., video service, cable service, audio service, gaming service). The one or more accounts may allow the user to access a variety of services from different devices. An account may be associated with a plurality of devices, such as premises devices, user devices, and/or the like. A master ledger associated with an account may comprise data from one of more of the plurality of devices associated with the account. Only data associated with a specific account may be stored in a master ledger associated with that account. Data from other accounts may not be stored on a master ledger associated with an account. A master ledger may be generated for a specific account if a device associated with an account sends a request to add data to a ledger. The one or more master ledgers may comprise master ledgers that comprise an aggregation of data blocks stored on device ledgers associated with an account.

The storage device 104 may comprise a network ledger (e.g., cloud ledger). The network ledger may comprise all (or a portion) of the one or more master ledger. The network ledger may comprise a data store, such as a database. The network ledger may comprise a plurality of entries. An example entry may comprise an identifier associated with an account. The entry may comprise a data block of a master ledger of an account. The entry may associate the data block and the account identifier. A first entry of the network ledger may comprise a data block (e.g., and transaction) associated with a first account. A second entry of the network ledger may comprise a data block (e.g., and transaction) associated with a second account. The second entry may be stored adjacent to, subsequent to, next to, following, the first entry. In such implementation, an example master ledger may comprise a plurality of entries stored (e.g., separately) among entries associated with other master ledgers. The master ledger may be determined by querying for entries having a specific account number associated with the master ledger.

An example master ledger may comprise one or more data blocks. The one or more ledger nodes 102 may be configured to add data blocks to the one or more master ledgers. The size of a data block may be limited to a threshold size. An example size may comprise 1 kb, 2 kb, 5 kb, 10 kb, and/or the like. The threshold size may be based on a storage capacity of devices associated with a master ledger. A data block may be limited to a single transaction (e.g., record, association, parameter). Instead of combining multiple data transactions into a single block, the one or more ledger nodes 102 may be configured to generate a block based on a single transaction.

An example data block may comprise data associated with an account. The data may comprise a record, a transaction, an identity, an association (e.g., an association of a device with an account), an authorization, a parameter (e.g., device setting, account setting, service level), a condition (e.g., length of time that a record, transaction, identity, association, and/or authorization is valid), a combination thereof, and/or the like. The data may compromise an access grant (e.g., permission grant), an access revocation (e.g., permission revocation), a time based authorization, a combination thereof, and/or the like. The one or more master ledgers may be linked ledgers. An example data block may comprise data linking (e.g., associating) a data block with another data block. A data block may comprise a cryptographic hash of a prior data block.

The one or more ledger nodes 102 (e.g., miners) may be configured to generate data blocks based on a ledger process (e.g., blockchain process, mining process, linking process). A data block may be added to a master ledger if the master ledger is determined to be valid. As described further herein, the one or more ledger nodes 102 may validate each data block to determine that the ledger is valid. If the data is valid, the one or more ledger nodes 102 may perform the ledger process.

The ledger process may comprise generating a data block (e.g., for storing data associated with an account). The data block may be added to a master ledger associated with an account. The ledger process may be based on a consensus algorithm, such as proof of work, proof of stake, or proof of identity. Proof of identity may be based on an authorization, an identity, a certificate, and/or the like. The proof of identity process may be managed by a certificate authority. The one or more ledger nodes 102 (e.g., or processing instances executing thereon) may each have an authorized identity. The one or more ledger nodes 102 (e.g., or processing instances executing thereon) may each comprise a certificate (e.g., generated by a certificate authority, to prove the authorized identity), such as a cryptographic certificate, cryptographic key, and/or the like. The one or more ledger nodes 102 may be in communication with each other via the network 130 or another private network.

The one or more ledger nodes 102 may generate one or more validation values associated with a data block. The one or more validation values may be used for validation of the last block (e.g., most recently added block) of a master ledger. Validation of the last block may comprise determining the last block has been deleted. At least a portion of the one or more validation values may be stored in the data block. The one or more validation values may be stored in a separate field, such as a header field, from a field used to store the data requested to be added to the distributed ledger. The one or more validation values may comprise a first validation value. The first validation value may be indicative of the data block. The first validation value may comprise a hash value, such as a hash value associated with (e.g., generated based on) a transaction stored in the block, a hash value associated with generating the data block, and/or the like. The first validation value may comprise a merkle root value, such as a hash associated with the data to be added to the distributed ledger.

The one or more validation values may comprise a second validation value. The second validation value may be indicative of the ledger node 102 (e.g., or node, virtual machine) that generated the data block. The second validation value may comprise the first validation value signed by a key (e.g., private key) associated with ledger node 102 that generated the data block. The second validation value may be stored in a master signature table comprising a plurality of second validation values. The master signature table may be stored by the storage device 104. The following is an example format for storing the second validation value in the master signature table:

Sig:

{
Ledger: ledgerId
lastBlock: blockHeight
lastBlockHash: value
Sig: value (merkle root signed by Miners private key).
X509: value (miners certificate)
}

The ledger field may comprise an identifier of a specific distributed ledger. The lastBlock field may comprise a “height” of the last block (e.g., most recently added block) or indicator of a number of data blocks of a version of the distributed ledger. The lastBlockHash may comprise a hash value of the last block. The Sig field may comprise a signature value determined by using a private key (e.g., of a ledger node) to sign a hash of the data block (e.g., or merkle root). The X509 field may comprise a value of an X509 key and/or certificate associated with the ledger node adding the last block. Validation of a ledger may comprise comparing a block height in a ledger with the value of the lastBlock field. Validation of the ledger may comprise comparing a hash of the last block in the ledger to the value of the lastBlockHash field (e.g., second validation value). Validation of the ledger may comprise validating the value of the sig field based on the certificate value in the X509 field. The certification may also be validated to determine if the certificate is authorized.

Validation of a ledger (e.g., master ledger, device ledger) may comprise a validation process. The ledger process may be performed if the validation process indicates no error conditions. The validation process may comprise validation of blocks 0 though block n, where n is the last block of a ledger being validated. For purposes of illustration, a validation process for a ledger comprising block 0, block 1, and block 2 is described. The validation process may comprise determining block 0 (e.g., the first block) of a ledger being validated. Block 1 (e.g., the next block added after block 0) may be determined. Block 1 may be validated by computing a hash of block 0 and comparing the hash of block 0 to a value of a hash of block 0 stored in block 1. Block 1 may be validated by computing a hash of data (e.g., a transaction) stored in block 1 and comparing the computed hash to a merkle root value stored in block 1. Block 2 may be validated by computing a hash of block 1 and comparing the hash of block 1 to a value of a hash of block 1 stored in block 2. Block 2 may be validated by computing a hash of data (e.g., a transaction) stored in block 2 and comparing the computed hash to a merkle root value stored in block 2. A determination may be made that block 2 is the last block of the ledger. A last block height value stored in block 2 may be compared to a last block height value stored in a master signature table (e.g., which stores the last block height of each master ledger). A merkle root signed by the ledger node that added that last block may be stored in the master signature table. A certificate of the ledger node may also be stored in the signature table. The certificate may be validated to determine whether the ledger node was authorized. The certificate may be used to validate the merkle root signed by the ledger node. A last block hash stored in the master signature table may be used to validate (e.g., matched to) a hash of block 2. The merkle root stored in block 2 may be validated based on the merkle root signed by the ledger node. If no errors are found, then the ledger may be validated.

If a master ledger is validated (e.g., as part of processing a request to add a data block, using the validation process), the one or more ledger nodes 102 may add the requested data block to the ledger. An example data block (e.g., transaction, record) may be formatted as follows:

″header″: {
″blockHeight″: 4,
″merkleRootHash″: ″SNwkdAkSTvwsuPEvGo2ikaNqGtOiz2vebwOkB3S3IAc=″,
″nonce″: ″ej2ekR9ZMCqd63bC″,
″previousBlockHash″: ″zxktlLwL3XpWrAHHxbQmJ4v6ioBzDEUDGyYKwG6uunk=″,
″relayedBy″: ″1M9eYBk8muYSavKiHNCAPj5xt1Ks25qrXS″,
″timestamp″: 1522796225013,
″version″: 1
},

″input″: {

″publicKey″: ” .......zezsJ1Q1Mk7IPBJBTQqKA..........″,
″signature″:”.......GmxJAAiBpoBSX7IC44f........”
}
″inputNode″: ″1Engn4PNwQfrPdVCJqAMP4jhiTcXqhxiio″,
″ledgerId″: ″17DVMWxaKBu441u9oqqLmq62cw2qHQvJ3f″,
″notBefore″: 0,
″outputNode″: ″1DB7nrhWouhKqXgsSUuHBaQz25h1r1nSPy″
″recordVersion″: 1,
″targetNode″: ″1CRSfDoT6ytLv35LrR281AonjBaqfDAKWh″,
″txnId″: ″u9YWdDKvXYaBVS5k″,
″action″: ″allow″,
″blockHeight″: 4,
″createDate″ : ″2018-04-03T22:57:05.070Z″,
″exp″: 0,
″txnTime″: 1522796224331
}

The example data block is explained in more detail as follows. The ledgerId field may comprise a unique cryptographic hash derived from subscriber account number. The blockHeight field may comprise a numerical position of this data block in the chain starting at zero. The previousBlockHash field may comprise a cryptographic hash of the previous data block. The merkleRootHash field may comprise a cryptographic hash of the transaction contained in the block. The relayedBy field may comprise a unique identifier of the miner that created the data block. The Timestamp field may comprise a timestamp this block is created. The publicKey field may comprise a public key of the device sending the transaction. The Signature field may comprise a digital signature of the transaction using the devices private key. The inputNode field may comprise a unique address of the device sending the transaction. The outputNode field may comprise a unique address of the device receiving the grants in the transaction. The targetNode field may comprise a unique address of the target device where the grant is executed. The notBefore field may comprise a time before which the grant in the transaction is not applicable. The txnId field may comprise a random identifier of the transaction. The txnTime field may comprise a time the transaction was submitted by the sending device. The Expn field may comprise time the grant in the transaction is no longer applicable. The Action field may comprise a verb such as “Allow” or “revoke” that conveys an action or permission.

The data block may have, as an example, a specified size, a predefined size, a limited size, a constant size (e.g., a 1 kilobyte), and/or the like. The data block may comprise a header section (e.g., indicated by “header”) and an input section (e.g., indicated by “input”). The header section may comprise various fields, such as a record height (e.g., a number of records in a distributed ledger), a merkle root hash (e.g., a hash of transaction hashes in the data block), a nonce (e.g., a counter used by miners or ledger nodes to generate a correct hash), a previous record hash, relayed by (e.g., address of a device that relayed the record 500), timestamp, version, the like, and/or any combination of the foregoing.

The input section may comprise various fields, such as a public key, a signature, an input node, a ledger identifier (e.g., for identifying the distributed ledger associated with the account related to the transaction), a beginning date and/or time for permissions and/or rights granted by the transaction, an output node, a record version, a target node, a transaction identifier, an action (a description of what permissions and/or rights the transaction comprises), a record height, a date of generation, an expiration date and/or time for permissions and/or rights granted by the transaction, a transaction time, the like, and/or any combination of the foregoing.

The data block (e.g., a transaction or record therein) may be verified using values in the publicKey field and the signature field. A value in the inputNode field may identify a device associated with a user creating the transaction in the data block (e.g., the user granting the rights and/or permissions that are a subject of the data block, etc.). A value in outputNode may identify a device associated with a user receiving the rights and/or permissions that are the subject of the record. A value in the targetNode the may identify a device that is the subject of the rights and/or permissions. A value in the inputNode field may identify a mobile device associated with a primary account holder that is granting rights to access a camera to a second user; the value in outputNode field may identify a mobile device associated with the second user; and the value in targetNode field may identify the camera associated with the primary account holder.

A value in the Action field may indicate that the second user is allowed to access a premises device, such as camera. A value in the notBefore field may comprise a time representation and may indicate that the second user is allowed to access the camera immediately after the notBefore value. A value in the exp field may comprise a time representation and may indicate that the second user will not be allowed to access the premises device after a time of the indicated value has passed. A value of zero may indicate that access is always granted until permission to access the camera is revoked by the primary account holder. Permission to access the camera may be revoked by the primary account holder by adding a record to the distributed ledger comprising an action of “revoke”. It should be understood that the data block above is only one of a variety of ways for implementing the data block. Other fields and/or formatting may be used according specific implementation details.

The one or more ledger nodes 102 may be configured to validate a request to add data to a data block. The request may be validated based on one or more validation checks. The request may comprise a certificate associated with the device sending the request. The certificate may be issued by a certificate authority (e.g., managed by a service provider that provides the services). The one or more validation checks may comprise determining the certificate is issued by a trusted certificate authority, determining that the certificate is not expired, determining the data is digitally signed, determining that the request is associated with a valid account, and/or the like.

The one or more ledger nodes 102 may be configured to determine a condition (e.g., error condition, validation failure) associated with a request and/or the distributed ledger (e.g., version of the distributed ledger, master ledger, device ledger) associated with the request. The one or more ledger nodes 102 may determine the condition if the device sending the request is determined to be an authorized device (e.g., authorized to add data to a specific master ledger associated with an account). The one or more ledger nodes 102 may determine whether a device sending the request is an authorized device. A determination of whether the device is an authorized device may be based on verifying a certificate and/or other credentials associated with the device.

The condition may indicate that a first version of the distributed ledger does not match another version of the distributed ledger. Determining the condition may comprise determining that a data block of a version (e.g., master ledger, device ledger) of the distributed ledger has been added, removed, or modified. Determining the condition associated with the distributed ledger may comprise signature validation of all blocks and ensuring the next block's “previousBlockHash” matches the computed value of the current block.

If a ledger node receives a transaction from a device, the ledger node may performs a full ledger validation of the master version of the distributed ledger copy. If a block is tempered, fake block has been added, or a block has been deleted, the ledger node's validation may fail. The ledger node may return a condition (e.g., state, error condition) to the device indicating that there is a corruption in the ledger and new transaction cannot be added at this time. If the validation indicates no error condition, then the requested data may be added to the master ledger as a data block. The data block may be sent to the requesting device. Other devices may periodically check for new data block. The device receiving the added block may add the block to the device's version of the distributed ledger. The device receiving the added block may communicate the new block to other devices and/or otherwise send an instruction to the other devices to update the corresponding versions of the distributed ledger.

The consensus device 106 may comprise one or more computing devices. The consensus device may be a virtual device, such as a virtual machine (e.g., computing node) that is implemented by one or more computing devices. The consensus device 106 may be configured to determine an approved version of the distributed ledger. The consensus device 106 may receive a request to determine the approved version from the one or more ledger nodes 102 and/or a device associated with an account (e.g., a user device). The consensus device 106 may be configured to determine the approved version of the distributed ledger based on a consensus process (e.g., or consensus protocol).

The consensus process may comprise determining one or more versions of the distributed ledger associated with an account. The consensus device 106 may be configured to requests copies of versions of the distributed ledger from one or more devices associated with the account. The consensus device 106 may be configured to determine the one or more devices associated with the account. The consensus device 106 may determine the one or more devices associated with the account based on a list received a device sending the request, a data store (e.g., database) managed by the consensus device 106, by querying an external database, and/or the like.

The consensus process may comprise determining, from the copies of the versions of the distributed ledger, a version of the distributed ledger comprising the longest valid chain of data blocks. An example consensus process may comprise (e.g., or be conditioned upon) verifying the condition (e.g., error condition). The condition may be verified by performing a validation process (e.g., the same validation process used by the one or more ledger nodes 102, validation of blocks 0 through n, where n is the last block of a ledger being validated) on the master version of the distributed ledger. The consensus process may comprise applying the validation process (e.g., verifying prior block hash, verifying block added by authorized ledger node) to each received version of the distributed ledger. One or more versions of the distributed ledger may be selected that have the same genesis block and are represented in a threshold number (e.g., ⅔rds) of the received versions of the ledger. Of the selected one or more versions of the distributed ledger, a version of the ledger from among the selected versions of the distributed ledger that has the longest chain of data blocks may be determined as the approved ledger.

The premises 110 and 120 may comprise respective premises devices 112, 114, 116, 118 and 122, 124, 126, 128. The first premises 110 may comprise a gateway device 112 (e.g., a cable modem, a set-top box, a router, switch, a combination thereof.), a security device 114 (e.g., a sensor, a security system control device, a camera, a speaker, an alarm, smart lock), a user device 116 (e.g., a smart phone, a tablet, a wearable computing device, etc.), an internet of things (IoT) device 118 (e.g., a device to monitor performance of an appliance, a device to monitor inventory associated with an appliance, etc.), and/or the like. The second premises 120 may comprise a gateway device 112, a streaming device 124 (such as a set-top box, a cable modem, etc.), a user device 126 (e.g., mobile device), an IoT device 128 (e.g., automation device, smart appliance, sensor, thermostat, monitoring device), and/or the like.

Each premises 110 and 120 may communicate with the network 130 via a respective gateway device 112 and 122. Every other respective premises device 114, 116, 118 and 124, 126, 128 may communicate with the network 130 via a respective gateway device 112 and 122. Every set of respective premises devices 112, 114, 116, 118 and 122, 124, 126, 128 may communicate with each other via a respective gateway device 112 and 122. Each premises device 112, 114, 116, 118, 122, 124, 126, 128 may comprise one or more computing devices. Each premises device 112, 114, 116, 118 and 122, 124, 126, 128 may comprise a device ledger associated with a respective account. The account may be associated with a respective premises 110 and 120. A first account may be associated with the first premises 110 and/or associated with premises device 112, 114, 116, 118. A second account may be associated with the second premises 120 and/or premises devices 122, 124, 126, 128. In some scenarios, the first account may be associated with the first premises 110 and the second premises 120.

Each gateway device 112 and 122 may communicate with the one or more ledger nodes 102 via the network 130. Each gateway device 112 and 122 may communicate with the consensus device 106 via the network 130.

Each user device 116 and 126 may execute a respective application. The application may allow a user to adjust permissions (e.g., or more generally, associations, authorizations, settings, parameters, and/or the like) with respective premises devices 112, 114, 116, 118 and 122, 124, 126, 128. A user associated with the premises 110 may adjust permissions associated with the security device 114. The user may send instructions for granting a new smart phone (e.g., friend's smart phone, or any other device) access to the security device 114 via the application executing on the user device 116. The user device 116 may communicate the instructions to the gateway device 112. The gateway device 112 may send the instructions to the ledger node 102 via the network 130. The user device 116 may communicate the instructions to the ledger node 102 via a telecommunications link to the network 130. The ledger node 102 may use the ledger process to add a block with the instructions to the master ledger. The security device 114 may update its device ledger based on the master ledger. The ledger node 102 may send an updated copy of a device ledger to the security device. The other premises devices 112, 116, 118, at the premises 110 may update their respective device ledgers.

The new smart phone may execute a respective application. The new smart phone may request access to the security device 114 via the application. The application may cause the request to be transmitted to the gateway device 112 via the network 130. The gateway device 112 may forward the request to the security device 114. The security device 114 may check its device ledger to see if the request for access is from an authorized device. Because the device ledger comprises a block that indicates that the new smart phone is authorized to access the security device 114, the security device 114 may permit the new smart phone to access the security device 114.

The network 130 may facilitate communication between the one or more ledger nodes 102, the consensus device 106, and the premises devices 112, 114, 116, 118 and 122, 124, 126, 128 at the respective premises 110 and 120. The network 130 may comprise a local area network (LAN). The one or more ledger nodes 102 and/or the consensus device 106 may be remote from the one or more premises 110 and 120. The network 130 may comprise a wide area network. The network 130 may comprise a private portion. The network 130 may comprise a public portion, such as the Internet. The network 130 may comprise a physical connection, such as an Ethernet connection. The network 130 may comprise a wireless connection, such as Wi-Fi.

A respective application running on the user device 126 may detect a condition (e.g., error condition) and/or receive a notification of a condition from one of the ledger nodes 102. The condition may comprise an inconsistency in the master ledger. An example condition may comprise a version (e.g., master ledger, device ledger) of the distributed ledger comprising an invalid block. A condition may comprise a version (e.g., master ledger, device ledger) of the distributed ledger missing a data block (e.g., or comprising a data block missing from another version of the distributed ledger). A condition may comprise a version (e.g., master ledger, device ledger) of the distributed ledger missing the last block (e.g., or comprising a last block that is missing from another version of the distributed ledger). The application may create a request to initiate a consensus process (e.g., consensus protocol). The application may create the request to initiate the consensus process based on (e.g., in response to receiving) the condition. The user device 126 may send the request to initiate the consensus process to the gateway device 122. The gateway device 122 may send the request to initiate the consensus process to the consensus device 106 via the network 130. The user device 126 may send the request to initiate the consensus protocol to the consensus device 106 via a telecommunications link to the network 130.

The consensus device 106 may begin the consensus process. The consensus device 106 may begin the consensus process based on (e.g., in response to, after receiving) request to initiate the consensus process. The consensus device 106 may request a device ledger from each of the premises devices 122, 124, 126, 128 at the premises 120. After the consensus device 106 receives each of the device ledgers or after a predetermined time has passed, the consensus device 106 may determine which of the received device ledgers is an approved ledger based on a consensus process. The consensus process may comprise one or more of the following:
(a) Validate submitted device ledgers—all blocks may be verified to be cryptographically linked to the previous block.
(b) Pick a device ledger that has the same genesis block and is represented in ⅔ or more submitted ledgers.
(c) Of the selected ledgers based on condition (b) above, pick the longest chain.

The consensus device 106 may use a Byzantine fault tolerance algorithm to update the one or more versions (e.g., master ledger, device ledger) of the distributed ledger. The consensus device 106 may send a notification that the one or more versions of the distributed ledger has been updated to each of the premises devices 122, 124, 126, 128 associated with the premises 120 via the network 130. Each of the premises devices 122, 124, 126, 128 may send a request at least a portion of the master ledger to one of the ledger nodes 102 to update the respective device ledger.

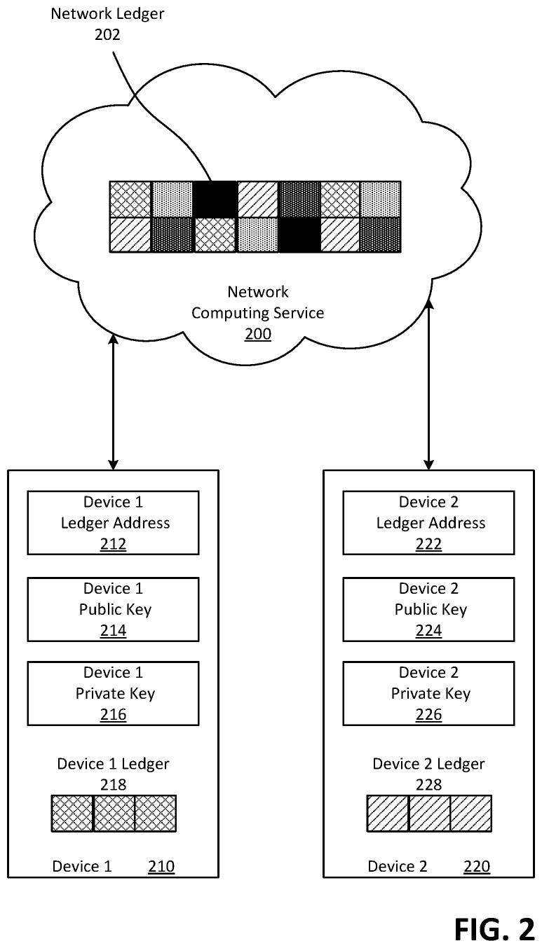

FIG. 2 shows an example block diagram of a network ledger 202. The network ledger 202 may be stored and/or managed by a network computing service 200 (e.g., cloud computing service). The network ledger 202 may comprise data blocks from a plurality of different accounts. The network ledger 202 may comprise a plurality of master ledgers associated with corresponding accounts of the plurality of different accounts. Data blocks associated with particular account may be a master ledger associated with the account. The network computing service 200 may be in communication with a plurality of devices, such as a first device 210 and a second device 220. The network computing service 200, the first device 210, and/or the second device 220 may comprise one or more computing devices. The first device 210 and/or the second device 220 may comprise a premises device 112, 114, 116, 118, 122, 124, 126, 128 of FIG. 1. The network 130 of FIG. 1 may comprise the network computing service 200. The first device 210 may be an internet of things (IoT) device. The second device 220 may be an IoT device. The first device 210 may be associated with a different account than the second device 220. The first device 210 may be located at a different premises than the second device 220.

The first device 210 may comprise a first ledger address 212. The first ledger address 212 may comprise a string of letters, numbers, characters, symbols, etc. Data (e.g., transactions, records on the distributed ledger) comprising the first ledger address 212 may be identified as created by the first device 210. Data comprising the first ledger address 212 may comprise permission information regarding the first device 210.

The first device 210 may comprise a first public key 214. The first public key 214 may comprise a string of letters, numbers, characters, symbols, etc. Data (e.g., transactions, records, signatures) encrypted by the first device 210 may be decrypted with the first public key 214. An assumption may be made that the first device 210 encrypted data if the data can be decrypted using the first public key 214. The first public key 214 may be made available to other computing devices.

The first device 210 may comprise a first private key 216. The first private key 216 may comprise a string of letters, numbers, characters, symbols, etc. The first device 210 may encrypt data, generate a hash, generate a signature, and/or the like using the first private key 216. An assumption may be made that the first device 210 encrypted data with the first private key 216 if the data can be decrypted using the first public key 214. The first private key 216 should not be made available to other computing devices. The first private key 216 may be used to sign (e.g., hash, cryptographically sign) data (e.g., messages, transactions) sent by the first device 210.

The first device 210 may comprise a first device ledger 218. The first device ledger 218 may comprise a plurality of blocks. The first device 210 may retrieve the plurality of blocks from the network ledger 202. The plurality of blocks may be stored by the network computing service 200 as a master ledger associated with a first account. The plurality of blocks may comprise data blocks (e.g., records, transactions) relevant to (e.g., related to, associated with) the first device 210. The plurality of blocks may comprise data blocks (e.g., records, transactions) relevant to devices at a premises comprising the first device 210.

If a device requests permission to access the first device 210, the first device 210 may check the first device ledger 218 to see if a record in the first device ledger 218 indicates that the device requesting permission to access the first device 210 has such permission. If such permission is found, then the first device 210 may grant access to the device requesting permission. If no such permission is found, then the first device 210 may reject access to the device requesting permission.

If a permission is changed, then the first device 210 may create a block indicating the permission in the first device ledger 218. If a permission is changed, then the first device 210 may cause a miner in the network computing service 200 to create a block indicating the changed permission in the network ledger 202. The first device 210 may download relevant blocks of the network ledger 202. The miner may be a ledger node 102 of FIG. 1.

The second device 220 may comprise a second ledger address 222. The second ledger address 222 may comprise a string of letters, numbers, characters, symbols, etc. Records comprising the second ledger address 222 may be identified as created by the second device 220. Records comprising the second ledger address 222 may comprise permission information regarding the second device 220.

The second device 220 may comprise a second public key 224. The second public key 224 may comprise a string of letters, numbers, characters, symbols, etc. Data encrypted by the second device 220 may be decrypted with the second public key 224. An assumption may be made that the second device 220 encrypted data if the data can be decrypted using the second public key 224. The second public key 224 may be made available to other computing devices.

The second device 220 may comprise a second private key 226. The second private key 226 may comprise a string of letters, numbers, characters, symbols, etc. The second device 220 may encrypt data using the second private key 226. An assumption may be made that the second device 220 encrypted data with the second private key 226 if the data can be decrypted using the second public key 224. The second private key 226 should not be made available to other computing devices. The second private key 224 may be used to sign (e.g., hash, cryptographically sign) data (e.g., messages, transactions) sent by the second device 220.

The second device 220 may comprise a second device ledger 228. The second device ledger 228 may comprise a plurality of blocks. The second device 220 may retrieve the plurality of blocks from the network ledger 202. The plurality of blocks may be stored by the network computing service 200 as a master ledger associated with a second account. The plurality of blocks may comprise data blocks (e.g., records, transactions) relevant to the second device 220. The plurality of blocks may comprise records relevant to devices at a premises comprising the second device 220.

If a device requests permission to access the second device 220, the second device 220 may check the second device ledger 228 to see if a record in the second device ledger 228 indicates that the device requesting permission to access the second device 220 has such permission. If such permission is found, then the second device 220 may grant access to the device requesting permission. If no such permission is found, then the second device 220 may reject access to the device requesting permission.

If a permission is changed, then the second device 220 may create a block indicating the permission in the second device ledger 228. If a permission is changed, then the second device 220 may cause a miner in the network computing service 200 to create a block indicating the changed permission in the network ledger 202. The second device 220 may download relevant blocks of the master ledger 202. The miner may be a ledger node 102 of FIG. 1.

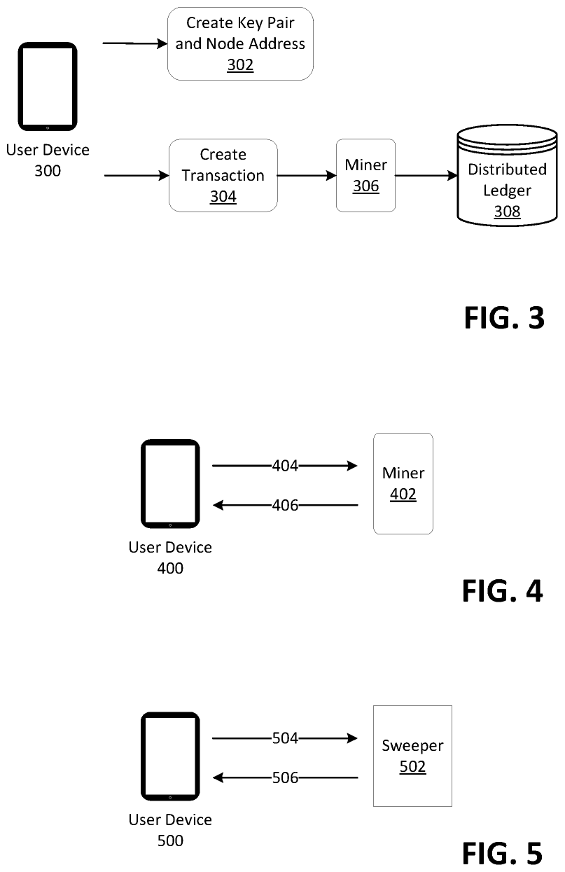

FIG. 3 shows example sequences for editing a master ledger 308. A user may execute an application on a user device 300. The user device 300 may comprise and/or be in communication with one or more premises devices 112, 114, 116, 118, 122, 124, 126, 128 of FIG. 1. The user device 300 may comprise one or more computing devices.

At 302, a user device 300 may determine (e.g., generate, create) identification information. The identification information may comprise a key pair. The key pair may comprise a public key and a private key. The information may comprise address information, such a node address.

The public key may comprise a string of letters, numbers, characters, symbols, etc. The private key may comprise a string of letters, numbers, characters, symbols, etc. Information encrypted by the user device 300 may be decrypted with the public key. An assumption may be made that the user device 300 encrypted the information if the information can be decrypted using the public key. The public key may be made available to other computing devices, such as a miner 306. The user device 300 may encrypt records using the private key. An assumption may be made that the user device 300 encrypted a record with the private key if the record can be decrypted using the public key. The private key should not be made available to other computing devices.

The node address may comprise a device address. The node address may comprise a user address. The node address may comprise a string of letters, numbers, characters, symbols, etc. Data (e.g., transactions, records, messages) comprising the node address may be identified as created by the user device 300. Data comprising the node address may be identified as created by a user associated with the user device 300. Data comprising the node address may comprise permission information regarding the user device 300. Data comprising the node address may comprise permission information regarding the user associated with the user device 300.

The identification information (e.g., key pair and/or node address) may be determined as part of a configuration process associated with the user device 300 (e.g., or an application of the user device). The key pair and/or node address may be determined as part of a configuration process associated with the user device 300. The key pair and/or node address may be determined as part of a configuration process associated with the user device 300 based on (e.g., in response to, or after) the user signing into to an application for the first time. The application may be configured to determine the keypair and/or node address based on pre-configured logic, such as random generation, querying a server, and/or the like. The private key may be used to generate a digital signature for a message, transaction, and/or other data.

At 304, the user device 300 may create a transaction. The transaction may comprise the node address. The transaction may comprise a timestamp. The user device 300 may sign the transaction and/or a message comprising the transaction with the private key. The transaction may be sent to the miner 306. The miner 306 may comprise a computing device, a computing node (e.g., virtual machine), server and/or the like implemented by network computing service (e.g., cloud computing service). The miner 306 may be a ledger node 102 of FIG. 1.

The miner 306 may receive a message comprising the transaction. The miner 306 may validate the message and/or transaction. The miner 306 may validate an account associated with the transaction. The miner 306 may validate the transaction as digitally signed by the user device 300. The miner 306 may validate a digital certificate that may accompany the transaction. The miner 306 may validate the digital certificate as not expired. The miner 306 may validate the digital certificate as issued by a trusted certificate authority. If the transaction passes all the validation checks, then the miner 306 may determine whether the user device 300 has an associated distributed ledger (e.g., a leaf ledger). The user device 300 may be associated with an account. A determination may be made as to whether the account has an associated distributed ledger. If no distributed ledger has been associated with the account (e.g., or generated for the account), then the miner 306 may determine to generate a distributed ledger associated with the account. The miner 306 may generate the distributed ledger by generating a master version of the distributed ledger.

If the transaction passes all the validation checks, then the miner 306 may determine that the transaction is approved. If the miner 306 determines that the transaction is approved to be added to the master ledger 308, then the miner 306 may add the transaction to the distributed ledger 308. The miner 306 may create a block. The block may comprise the transaction. The miner 306 may add the block to a master version of the distributed ledger 308.

FIG. 4 shows an example communication sequence between a user device 400 and a miner 402. The user device 400 and/or the miner 402 may comprise one or more computing devices. The user device 400 may comprise and/or be in communication with one or more premises devices 112, 114, 116, 118, 122, 124, 126, 128 of FIG. 1. The miner 402 may comprise a ledger node 102 of FIG. 1. The user device 400 may comprise an application to facilitate communication with the miner 402.

The user device 400 may create and send a communication 404 to the miner 402. The user device 400 may use the application to create and send a communication 404 to the miner 402. The communication 404 may comprise data from a premises device, such an IOT device, security device, automation device, and/or the like. The communication 404 may comprise a request to read and/or write to a distributed ledger (e.g., or a master version of the distributed ledger) via the miner 402. The communication 404 may comprise a certificate.

The certificate may be associated with an internet of things (IoT) device. The communication 404 may comprise a Hypertext Transfer Protocol (HTTP) message. The communication 404 may comprise a HTTP GET message. The communication 404 may comprise a HTTP POST message. THE HTTP message may identify one or more of a uniform resource identifier, an application programming interface call, an identifier of the distributed ledger and/or the like. For an example ledger having an identifier of 123, an example message may comprise a POST or GET message comprising a uniform resource identifier of “miner/v1/ledger:123”.

The miner 402 may detect a problem with the distributed ledger (e.g., or a version of the distributed ledger). A problem with the distributed ledger may comprise an invalid block in the distributed ledger, a missing block in the distributed ledger, a missing last block in the distributed ledger, etc. The miner 402 may send an error message 406 to the user device 400. The miner 402 may send an error message 406 to the user device 400 based on (e.g., in response to, or after) detecting the problem with the distributed ledger. A communication sequence in FIG. 5 may be initiated. The communication sequence in FIG. 5 may be initiated based on (e.g., in response to) the error message 406.

FIG. 5 shows an example communication sequence between a user device 500 and a sweeper 502. The user device 500 and/or the sweeper 502 may comprise one or more computing devices. The user device 500 may comprise and/or be in communication with one or more premises devices 112, 114, 116, 118, 122, 124, 126, 128 of FIG. 1. The sweeper 502 may comprise the consensus device 106 of FIG. 1. The user device 500 may comprise the user device 400 in FIG. 4. The example communication sequence may be initiated based on (e.g., in response to, or after) the error message 406 in FIG. 4. The sweeper 502 may comprise the consensus device 106 in FIG. 1. The user device 500 may comprise an application to facilitate communication with the sweeper 502.

The user device 500 may create and send a communication 504 to the sweeper 502. The user device 500 may use the application to create and send a communication 504 to the sweeper 502. The communication 504 may comprise a consensus process initiation call (e.g., rescue call, SOS call, etc.) to the sweeper 502. The communication 504 may comprise a certificate. The communication 504 may comprise a certificate associated with a premises device, such as an IOT device, security device, or automation device. The communication 504 may comprise an address associated with the user device 500. The communication 504 may comprise a device ledger. The device ledger may be associated with the user device 500. The device ledger may be associated with an account (e.g., premises, subscriber, user, etc.) associated with the user device 500. The communication 504 may comprise a Hypertext Transfer Protocol (HTTP) message. The communication 504 may comprise a HTTP GET message. The communication 504 may comprise a HTTP POST message.

The sweeper 502 may initiate a consensus process. The sweep may initiate the consensus process based on (e.g., in response to) the communication 504. The sweeper 502 may send a communication 506 to the user device 500. The communication 506 may indicate that the consensus process has started. As part of the consensus process, the sweeper 502 may check a state of a master version of the distributed ledger (e.g., master ledger, network ledger, etc.). Consensus process may determine the current state of the master ledger by validating all blocks cryptographically and linked to the corresponding prior block. The master version of the distributed ledger may be validated by using the validation process described further herein. If the sweeper 502 determines that the master version of the ledger has an inconsistent state (e.g., error condition), then the sweeper 502 may end the consensus process.

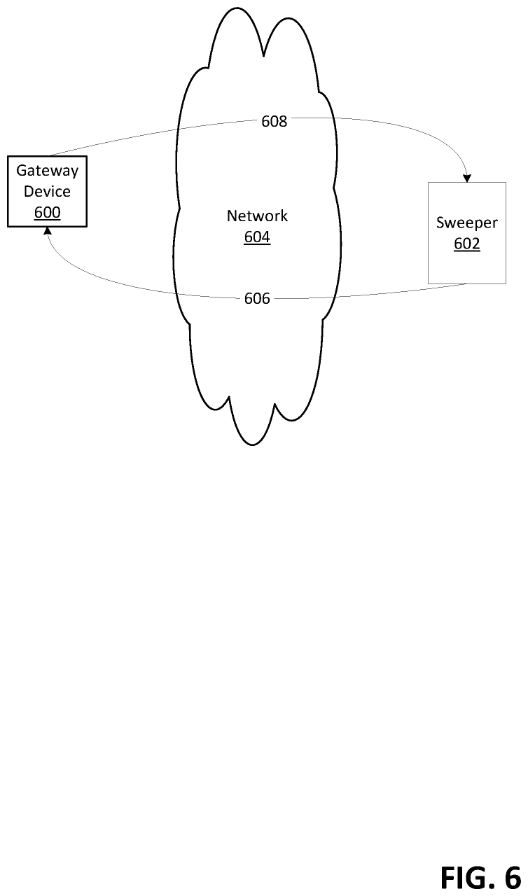

If the sweeper 502 determines that the master ledger comprises an inconsistent (e.g., corrupt, bad, etc.) state, then the sweeper 502 may initiate communication with the premises devices associated with a premises associated with the user device 500. FIG. 6 may show one such communication. The sweeper 502 may send a request for a respective device ledger to each of the premises devices associated with a premises associated with the user device 500. The premises devices associated with the premises associated with the user device 500 may send (e.g., post, transmit, etc.) their respective device ledgers to the sweeper 502. The premises devices may send their respective device ledgers to the sweeper 501 based on (e.g., in response to, or after) the request.

The sweeper 502 may comprise a same validation process as the miners, such as the miner 402 in FIG. 4. The validation process may comprise checking each data block for consistency with a merkle root value of the block and ensuring the previousBlockHash value matches hash of the block the previous block. For each of the received device ledgers, the sweeper 502 may start at a block zero and validate each block using a hashing algorithm. The sweeper 502 may check a merkle root value associated with a last block of each of the received device ledgers against a signature table. The sweeper 502 may eliminate any device ledger with invalid blocks. The sweeper 502 may select a longest remaining device ledger. The sweeper 502 may save the current, inconsistent master ledger. The sweeper 502 may cause the master ledger to be updated using the selected longest remaining device ledger. The sweeper 502 may send an indication that the master ledger has been updated to the premises devices associated with the premises associated with the user device 500. Each of the premises devices associated with the premises associated with the user device 500 may download a respective portion of the master ledger and use the downloaded portion to update a respective device ledger. Each of the premises devices associated with the premises may download the respective portion of the master ledger based on (e.g., in response to the indication).

FIG. 6 shows an example communication sequence between a gateway device 600 and a sweeper 602. The gateway device 600 and/or the sweeper 602 may comprise one or more computing devices. The gateway device 600 may comprise and/or be in communication with one or more premises devices 112, 114, 116, 118, 122, 124, 126, 128 of FIG. 1. The sweeper 602 may comprise the consensus device 106 of FIG. 1. The sweeper 602 may comprise the sweeper 502 in FIG. 5. The example communication sequence may be initiated based on (e.g., in response to, after) the sweeper 502 determining that the master ledger comprises an inconsistent state during the consensus process in FIG. 5. The gateway device 600 may communicate with the sweeper 602 via a network 604. The network 604 may comprise the network 130 in FIG. 1.

The sweeper 602 may send a communication 606 to the gateway device 600 via the network 604. The communication 606 may comprise a request for a device ledger of the gateway device 600 and/or a device ledger of a device in communication with the gateway device 600. The communication 606 may comprise a request for one or more (or all) versions of a distributed ledger associated with an account (e.g., or user, or premises). The gateway device 600 may be located at a premises. The one or more premises device in communication with gateway device 600 may be located at the premises. The gateway device 600 may forward the communication 606 to the one or more premises devices (e.g., or may generate new requests to each device associated with the account based on the communication 606).

The gateway device 600 may send a communication 608 to the sweeper 602 via the network 604. The gateway device 600 may send the communication 608 to the sweeper based on (e.g., in response to) the communication 606. The communication 608 may comprise a certificate. The certificate may comprise a certificate of a premises device. The communication 608 may comprise an address associated with the gateway device 600. The communication 608 may comprise a device ledger. The device ledger may be associated with the gateway device 600 or a premises device. The device ledger may be associated with an account (e.g., premises, subscriber, user, etc.) associated with the gateway device 600. One or more premises devices, such as a first IoT device and a second IoT device may send corresponding versions of the distributed ledger based on (e.g., in response to) a request forwarded from the gateway device.

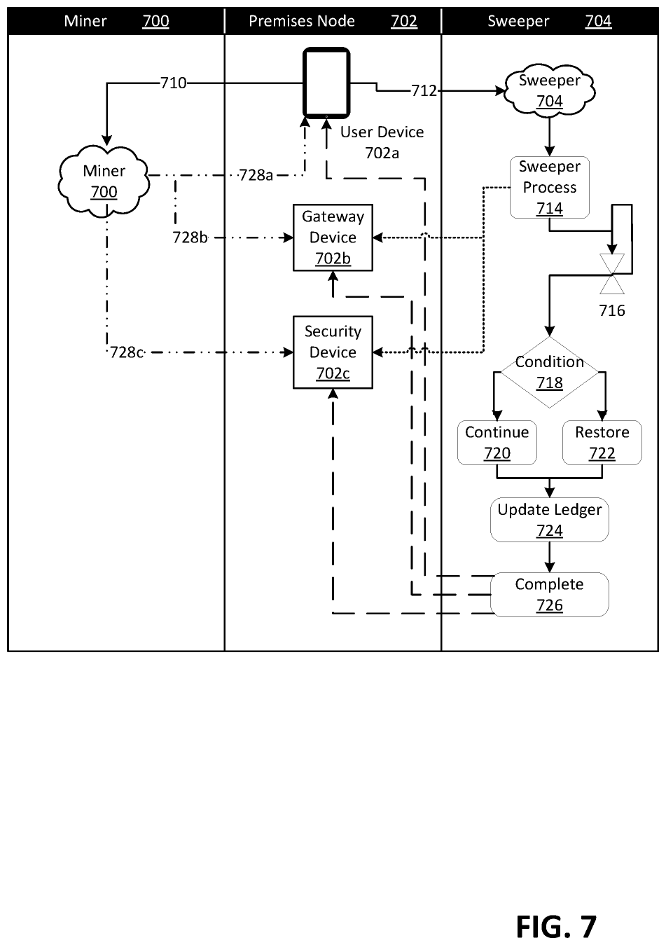

FIG. 7 shows an example communication sequence between one or more premises nodes 702, a miner 700, and a sweeper 704. The one or more premises nodes 702 may comprise a user device 702a, a gateway device 702b, and a security device 702c. The miner 700, the user device 702a, the gateway device 702b, the security device 702c, other premises nodes 702, and/or the sweeper 704 may comprise one or more computing devices. The miner 700 and/or the sweeper 704 may be implemented via a network computing service. The miner 700 may comprise one of the ledger nodes 102 in FIG. 1. The one or more premises nodes 702, the user device 702a, the gateway device 702b, and/or the security device 702c may each comprise and/or be in communication with premises device 112, 114, 116, 118, 122, 124, 126, 128 of FIG. 1. The sweeper 704 may comprise the consensus device 106 in FIG. 1. The user device 702a may comprise an application to facilitate communication with the miner 700 and the sweeper 704.

The user device 702a may create and send a communication 710 to the miner 700. The user device 702a may use the application to create and send a communication 710 to the miner 700. The communication 710 may comprise an attempt to read and/or write to a master ledger via the miner 700. The master ledger may comprise a master version of a distributed ledger associated with an account. The distributed ledger may be restricted to users associated with the account. The communication 710 may comprise a certificate, such as a certificate of a device sending the communication. The communication 710 may comprise a Hypertext Transfer Protocol (HTTP) message. The communication 710 may comprise a HTTP GET message. The communication 710 may comprise a HTTP POST message.

The miner 700 may detect a problem with the master ledger. A problem with the master ledger may comprise an invalid block in the master ledger, a missing block in the master ledger, a missing last block in the master ledger, etc. The miner 700 may send an error message to the user device 702a. The miner 700 may send the error message to the user device 702a based on (e.g., in response to) detecting the problem with the master ledger.

The user device 702a may create and send a communication 712 to the sweeper 704. The user device 702a may create and send the communication 712 to the sweeper 704 based on (e.g., in response to) the error message. The user device 702a may use the application to create and send a communication 712 to the sweeper 704. The communication 712 may comprise a consensus process initiation call (e.g., rescue call, SOS call, etc.) to the sweeper. The communication 712 may comprise a certificate. The communication 712 may comprise a certificate associated with the user device 702a (e.g., or a certificate of another device, such as a premises device, IoT device, security device, automation device). The communication 712 may comprise an address associated with the user device 500. The communication 712 may comprise a device ledger (e.g., or local ledger). The device ledger may be associated with (e.g., stored on) the user device 702a. The device ledger may comprise a partial version of the distributed ledger. The communication 712 may comprise a Hypertext Transfer Protocol (HTTP) message. The communication 712 may comprise a HTTP GET message. The communication 712 may comprise a HTTP POST message.

The sweeper 704 may send a message to the user device 702a indicating that the sweeper (e.g., consensus protocol, etc.) process has started. The sweeper 704 may send the message to the user device 702a indicating that the sweeper (e.g., consensus protocol, etc.) process has started based on (e.g., in response to the communication 712). At 714, the sweeper process may begin. The sweeper process may begin based on (e.g., in response to) the communication 712. As part of the sweeper process, the sweeper 704 may request a device ledger from each of the gateway device 702b and the security device 702c.

At 716, the sweeper 704 may wait for a response from the gateway device 702b and the security device 702s. The sweeper 704 may wait for a predetermined time. The predetermined time may be 40 seconds, or any other appropriate time. At 718, the sweeper 704 may stop waiting. If the sweeper 704 stops waiting because the predetermined time expired, then the sweeper 704 may continue at 720 with the ledger data available. If the sweeper 704 stops waiting because the sweeper 704 received device ledgers from the gateway device 702b and the security device 702c, then at 722 the sweeper 704 may use consensus logic to determine an approved ledger for the one or more premises nodes 702 using device ledgers from the user device 702a, the gateway device 702b, and the security device 702c.

At 724, the sweeper 704 may use a Byzantine fault tolerance algorithm to select a device ledger from each of the received device ledgers. The sweeper 704 may comprise a same mining algorithm (e.g., ledger process) as the miner 700. For each of the received device ledgers, the sweeper 704 may start at a block zero and validate each block using the mining algorithm (e.g., ledger process). The sweeper 704 may check a merkle root value associated with a last block of each of the received device ledgers against a signature table. The sweeper 704 may eliminate any device ledger with invalid blocks. The sweeper 704 may select a longest (e.g., most blocks in a chain) remaining device ledger. The sweeper 704 may save the current, inconsistent master ledger. The sweeper 704 may cause the master ledger to be updated using the selected longest remaining device ledger.

At 726, the sweeper process may be completed. The sweeper 704 may send an indication that the master ledger has been updated to the each of the one or more premises nodes 702. The sweeper 704 may send an indication that the master ledger has been updated to the user device 702a, the gateway device 702b, and the security device 702c. Each of the premises nodes 702 may contact (e.g., engage, communicate with, use, etc.) the miner 700 to download a respective portion of the master ledger. The premises nodes 702 may contact the miner 700 based on (e.g., in response to) the indication. The user device 702a may contact the miner 700 to download a respective portion of the master ledger 728a to update a device ledger. The gateway device 702b may contact the miner 700 to download a respective portion of the master ledger 728b to update a device ledger. The security device 702c may contact the miner 700 to download a respective portion of the master ledger 728c to update a device ledger.

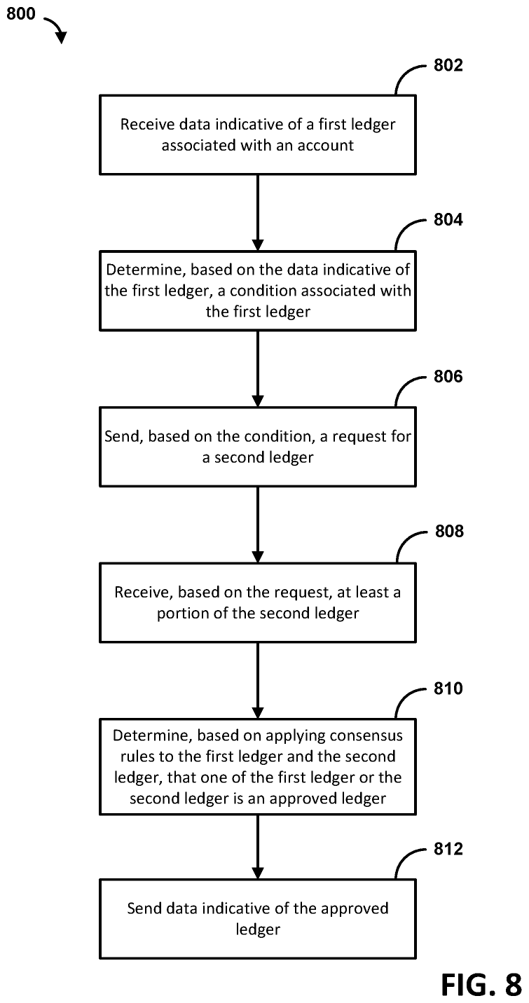

FIG. 8 shows a flow diagram of an example method 800. At step 802, data indicative of a first ledger associated with an account may be received. The consensus device 106 in FIG. 1 may receive data indicative of a ledger associated with the IoT device 118 in FIG. 1 associated with an account. The account may be associated with a subscriber of a service. The first ledger may be stored by a first device. The data indicative of the first ledger may be received from the first device. The first device may be associated with the account. The first device may comprise a user device associated with the account. The account may comprise a user account, such as a subscriber account (e.g., associated with a service). The data indicative of the first ledger may comprise a copy of the first ledger. The data indicative of the first ledger may comprise a reference (e.g., uniform resource locator) for accessing the first ledger.

At step 804, a condition associated with the first ledger may be determined based on the data indicative of the first ledger. The condition may comprise an error condition, an error state, a validation failure, failure state, a condition associated with failing a validation process, and/or the like. The consensus device 106 in FIG. 1 may determine a condition associated with the ledger associated with the IoT device 118 in FIG. 1 based on the data indicative of the ledger associated with the IoT device 118. The condition may be based on a determination that a data block of the first ledger has been added, removed, or modified. The condition may indicate that the first ledger does not match another version of the distributed ledger. The condition may be determined by comparing signature data in (e.g., or derived from) one or more blocks to a one or more entries in a data store of signature information. The data store may comprise a history of signature information. One or more of the signatures in the data store may be added based on generation of a corresponding data block.

At step 806, a request for a second ledger (e.g., or at least a portion of the second ledger) may be sent. The request may be sent based on the condition. The request may be sent to a second device associated with the account. The consensus device 106 in FIG. 1 may send a request for the ledger associated with the gateway device 112 in FIG. 1 based on the condition and to the gateway device 112 associated with the account. The condition may indicate that the first ledger does not match another version of the distributed ledger. Sending the request for the second ledger may comprise determining a plurality of devices associated with the account and sending, to the plurality of devices, requests for corresponding versions of the distributed ledger stored by the plurality of devices. The account may be associated with a premises. At least a portion of the plurality of devices may be located at the premises.

Transactions for a plurality of accounts associated with corresponding distributed ledgers may be added to the corresponding distributed ledgers by one or more computing devices external to the premises. A first device of the plurality of devices may be configured to authenticate, based on at least one data block of the distributed ledger, a second device of the plurality of devices. A first device of the plurality of devices may be configured to access, based on the authentication, one or more of content or a service associated with the second device.

The first ledger may be stored by a first device associated with the account. The second ledger may be stored by a second device associated with the account. The distributed ledger may comprise a plurality of transactions stored in corresponding data blocks. Each data block may comprise only one transaction of the plurality of transactions. At least a portion of the data blocks may be linked (e.g., cryptographically linked) to at least one corresponding preceding data block. The data blocks may be linked by including a hash from the last block (e.g., immediately preceding block).

A master version of the distributed ledger may be stored by a service platform comprising one or more computing devices configured to add transactions to the distributed ledger. Determining the condition associated with the first ledger may comprise comparing the first ledger to a third ledger comprising the master version of the distributed ledger. Determining the condition may comprise receiving, by a first device and from a second device, data indicative of the condition. At least one of a plurality of devices associated with the account may comprise a version of the distributed ledger that has less than all data blocks stored on the master version of the distributed ledger. The at least one of the plurality of devices may limit storage of the data blocks to data blocks that satisfy a condition (e.g., relevance to the device).

At step 808, at least a portion of the second ledger (e.g., a copy of the second ledger, one or more data blocks of the second ledger) may be received. At least the portion of the second ledger may be received based on the request. At least the portion of the second ledger may be received from the second device or another device (e.g., gateway at a premises in communication with the second device). The consensus device 106 in FIG. 1 may receive the ledger associated with the gateway device 112 in FIG. 1 based on the request. The second ledger may be one of many ledgers received from a plurality of devices associated with the account.

At step 810, a determination may be made that one of the first ledger or the second ledger is an approved ledger based on applying consensus rules to the first ledger and the second ledger. The consensus device 106 in FIG. 1 may determine that one of the ledger associated with the IoT device 118 in FIG. 1 or the ledger associated with the gateway device 112 in FIG. 1 is an approved ledger based on applying consensus rules to the ledger associated with the IoT device 118 and the ledger associated with the gateway device 112.

At step 812, data indicative of the approved ledger be sent. The data indicative of the approved ledger may comprise a copy of the approved ledger, a reference (e.g., uniform resource identifier), and/or the like. The data indicative of the approved ledger may comprise an indication that a master version of the distributed ledger is updated. The first device and/or the second device may proceed to retrieve a copy (e.g., or some of the data blocks) of the approved ledger. The consensus device 106 in FIG. 1 send data indicative of the approved ledger.

A consensus device may receive a message from an IoT device associated with an account. The message may comprise a device ledger stored by the IoT device. The device ledger may comprise a version of a distributed ledger associated with (e.g., and restricted to) the account. A plurality of versions of the distributed ledger may be stored on different devices associated with the account. A plurality of blocks of the received ledger and/or a master version of the distributed ledger may be validated. The consensus device may determine that the distributed ledger (e.g., or version thereof) may have (e.g., or is associated with) a condition (e.g., error condition, validation failure, etc). Based on the determination that the ledger has a condition, the consensus device may send a request for a ledger to a gateway device (e.g., or other premises device) associated with account. The consensus device may receive the ledger from the gateway device. The consensus device may determine which of the ledgers of the ledger received from the IoT device and the ledger received from the gateway device is an approved ledger. The consensus device may cause the master version of the ledger to be updated based on the approved ledger. The consensus device may cause the devices associated with the account, comprising at least the IoT device and the gateway device, to update respective device ledgers based on the updated master ledger.

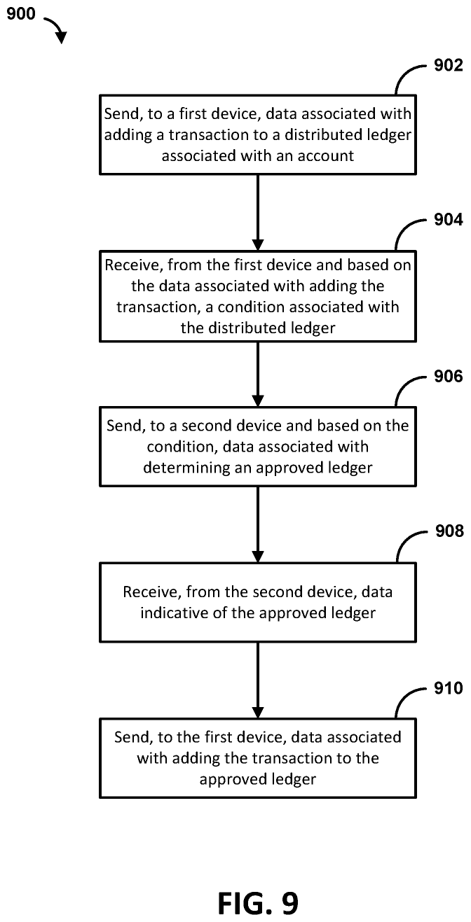

FIG. 9 shows a flow diagram 900 of an example method. At step 902, data associated with adding a transaction to a distributed ledger associated with an account may be sent to a first device. The IoT device 118 in FIG. 1 may send data associated with adding a transaction to a distributed ledger to the ledger node 102 in FIG. 1. The distributed ledger may be associated with an account. The distributed ledger may comprise a first ledger stored by a first computing device associated with the account. The distributed ledger may comprise a second ledger stored by a second computing device associated with the account. The distributed ledger may comprise a plurality of transactions stored in corresponding data blocks. Each data block may comprise only one transaction of the plurality of transactions. At least a portion of the data blocks may be linked (e.g., cryptographically linked) to at least one corresponding preceding data block. A master version of the distributed ledger may be stored by a service platform comprising a plurality of devices configured to add transactions to the distributed ledger. The account may be associated with a subscriber of a service.

At step 904, a condition associated with the distributed ledger may be received from the first device and based on the data associated with adding the transaction. The condition may comprise an error condition, an error state, a validation failure, failure state, a condition associated with failing a validation process, and/or the like. The IoT device 118 in FIG. 1 may receive a condition associated with the distributed ledger from the ledger node 102 in FIG. 1 and based on the data associated with adding the transaction. The condition may indicate that a first ledger comprising a first version of the distributed ledger does not match a second version of the distributed ledger. The condition may be based on a determination that a data block of the first ledger has been added, removed, or modified. The first device may be configured to determine the condition by comparing a first ledger comprising a first version of the distributed ledger to a second ledger comprising the master version of the distributed ledger. The condition may be determined by comparing signature data in (e.g., or derived from) one or more blocks to a one or more entries in a data store of signature information. The data store may comprise a history of signature information. One or more of the signatures in the data store may be added based on generation of a corresponding data block.

At step 906, data associated with determining an approved ledger may be sent to a second device. The data associated with determining the approved ledger may be sent based on (e.g., in response to receiving) the condition. The IoT device 118 in FIG. 1 may send data associated with determining an approved ledger to the consensus device 106 in FIG. 1 and based on the condition. The approved ledger may comprise an approved version of the distributed ledger determined based on applying a consensus algorithm to a plurality of versions of the distributed ledger received from one or more devices associated with the account. The second device may be configured to determine the one or more devices associated with the account and send, to the one or more devices associated with the account, requests for corresponding versions of the distributed ledger stored by the one or more devices associated with the account.

The account may be associated with a premises. At least a portion of the one or more devices associated with the account may be located at the premises. Transactions for a plurality of accounts associated with corresponding distributed ledgers may be added to the corresponding distributed ledgers by one or more computing devices external to the premises.

A first computing device of the one or more devices associated with the account may be configured to authenticate a second computing device of the one or more devices associated with the account based on at least one data block of the distributed ledger. The first computing device of the one or more devices associated with the account may be configured to access one or more of content or a service associated with the second computing device of the one or more devices associated with the account based on the authentication. At least one of the one or more devices associated with the account may comprise a version of the distributed ledger that has less than all data blocks stored on the master version of the distributed ledger.

At step 908, data indicative of the approved ledger may be received from the second device. The IoT device 118 in FIG. 1 may receive data indicative of the approved ledger from the consensus device 106. A copy of the approved ledger may be received. An identifier and/or a location to access the approved ledger may be received. An indication that a master version of the distributed ledger is approved and/or updated may be received.

At step 910, data associated with adding the transaction to the approved ledger may be sent to the first device. The IoT device 118 in FIG. 1 may send data associated with adding the transaction to the approved ledger to the ledger node 102. The first device may add the transaction to the approved ledger (e.g., or a master version of the distributed ledger).

A user may use an application executing on a first smart phone to grant a second smart phone permission to access an IoT device. The first smart phone and/or the IoT device may request that a miner add a block to a master version of a distributed ledger. The master version of the distributed ledger may be stored external to a premises where the IoT device is located. The master version of the distributed ledger may be managed by a network computing service. The block may comprise a transaction. The transaction may indicate that the second smart phone has permission to access the IoT device. The first smart phone and/or the IoT device may receive an error message from the miner. The first smart phone and/or the IoT device may send (e.g., based on the error message, in response to the error message) a rescue message to a sweeper. The rescue message may cause the sweeper to initiate a consensus protocol. The first smart phone and/or the IoT device may receive a message from the sweeper that the consensus protocol is complete. The first smart phone and/or the IoT device may request (e.g., based on or in response to receiving the message that the consensus protocol is complete) that the miner add the transaction to the master version of the distributed ledger. The transaction may be added to the master version of the distributed ledger as block (e.g., a block comprising a single transaction). The IoT device may receive an indication that the master version has been updated. The IoT device may download all or a portion of the master version of the distributed ledger. The IoT device may download only the block comprising the transaction. The second smart phone may send a request to the IoT device to access data and/or a function of the IoT device. The second smart phone may validate the request by determining that the block comprising the transaction comprises information indicative of an authorization of the second mobile device to access the IoT device. The information may comprise a time limit for accessing the IoT device. The IoT device may continue to grant access to the second smart phone until the time limit expires.

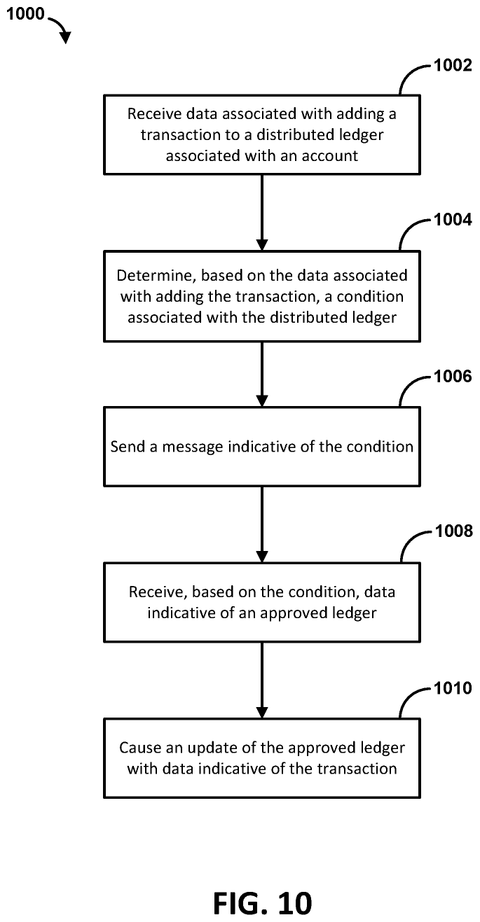

FIG. 10 shows a flow diagram 1000 of an example method. At step 1002, data associated with adding a transaction to a distributed ledger associated with an account may be received. The ledger node 102 in FIG. 1 may receive data associated with adding a transaction to a distributed ledger associated with an account. The distributed ledger may comprise a plurality of transactions stored in corresponding data blocks. Each data block may comprise only one transaction of the plurality of transactions. At least a portion of the data blocks may be cryptographically linked to at least one corresponding preceding data block. A master version of the distributed ledger may be stored by a service platform comprising a plurality of devices configured to add transactions to the distributed ledger. The account may be associated with a subscriber of a service.

At step 1004, a condition associated with the distributed ledger may be determined based on the data associated with adding the transaction. The condition may comprise a condition, an error state, a validation failure, failure state, a condition associated with failing a validation process, and/or the like. The ledger node 102 in FIG. 1 may determine a condition associated with the distributed ledger based on the data associated with adding the transaction. The condition may indicate that a first version of the distributed ledger does not match another version of the distributed ledger. Determining the condition may comprise determining that a data block of at least one version of the plurality of versions of the distributed ledger has been added, removed, or modified. Determining the condition associated with the distributed ledger may comprise comparing a version of the distributed ledger associated with the data associated with adding the transaction and the master version of the distributed ledger. The condition may indicate that the first ledger does not match another version of the distributed ledger. The condition may be determined by comparing signature data in (e.g., or derived from) one or more blocks to one or more entries in a data store of signature information. The data store may comprise a history of signature information. One or more of the signatures in the data store may be added based on generation of a corresponding data block.

At step 1006, a message indicative of the condition may be sent. The ledger node 102 in FIG. 1 may send a message indicative of the condition. The message may comprise a refusal to process the transaction. The message may comprise data indicating a specific type of condition, such as invalid block, missing block, missing last block, and/or the like. The message may comprise a command to send a message a device configured to perform a consensus process.

At step 1008, data indicative of an approved ledger may be received. The data indicative of the approved ledger may be received based on (e.g., in response to a request that was sent due to the condition) the condition. The ledger node 102 in FIG. 1 may receive data indicative of an approved ledger based on the condition. The approved ledger may comprise an approved version of the distributed ledger determined based on applying a consensus algorithm to a plurality of versions of the distributed ledger received from one or more devices associated with the account.

The plurality of versions of the distributed ledger may comprise a first version stored by a first device associated with the account and a second version stored by a second device associated with the account. At least one of the one or more devices associated with the account may comprise a version of the distributed ledger that has less than all data blocks stored on the master version of the distributed ledger.

The account may be associated with a premises. At least a portion of the one or more devices associated with the account may be located at the premises. A first device of the one or more devices associated with the account may be configured to authenticate a second device of the one or more devices associated with the account based on at least one data block of the distributed ledger. The first device may be configured to access one or more of content or a service associated with the second device based on the authentication.

At step 1010, the approved ledger may be caused to be updated with data indicative of the transaction. The ledger node 102 in FIG. 1 may update (e.g., or cause update of) the approved ledger with data indicative of the transaction. Another device, such as the consensus device 106, may cause the update of the approved ledger. The approved ledger may comprise a master version of the distributed ledger. The master version of the ledger may be updated based on another approved version (e.g., one stored on a premises device or other user device) of the distributed ledger. After updating the master version of the distributed ledger. The master version may be determined to be the approved ledger.

A plurality of users may have computing devices at corresponding premises. Each of the plurality of users may have a corresponding account. Transactions for a plurality of accounts associated with corresponding distributed ledgers may be added to corresponding distributed ledgers by one or more computing devices (e.g., referred to as miners) external to the premises.

A miner may receive a message to add a transaction to a master version of a distributed ledger for a specific account. The message may be receive from a premises device or a user device for a specific account. The transaction may indicate that a smart device should have permission to access the premises device. The message may comprise a device ledger by the premises device. The device ledger may comprise a version of the distributed ledger (e.g., a partial or fully copy of all the blocks of the distributed ledger). The miner may determine that the device ledger is inconsistent with a master version of the distributed ledger. The miner may determine that the device ledger and/or the master version of the distributed ledger has (e.g., or is associated with) a condition (e.g., error condition). The miner may send a message of the condition to the premises device.

The premises device may cause a sweeper device (e.g., external to the premises where the premises device is located) to execute a consensus protocol. The premises device may cause the sweeper device to execute the consensus protocol based on (e.g., in response to, after) receiving the condition. After the consensus protocol is complete, the sweeper device may send, to the premises device, a message indicating that the master version of the distributed ledger has been updated. The premises device may send, to the miner, a new message to add the transaction to the master version of the distributed ledger. The premises device may send the new message based on (e.g., in response to, after) receiving the message that the master ledger has been updated. The miner may add a block with the transaction to the master version of the distributed ledger. The new block may be added based on (e.g., in response to, after) receiving the new message.

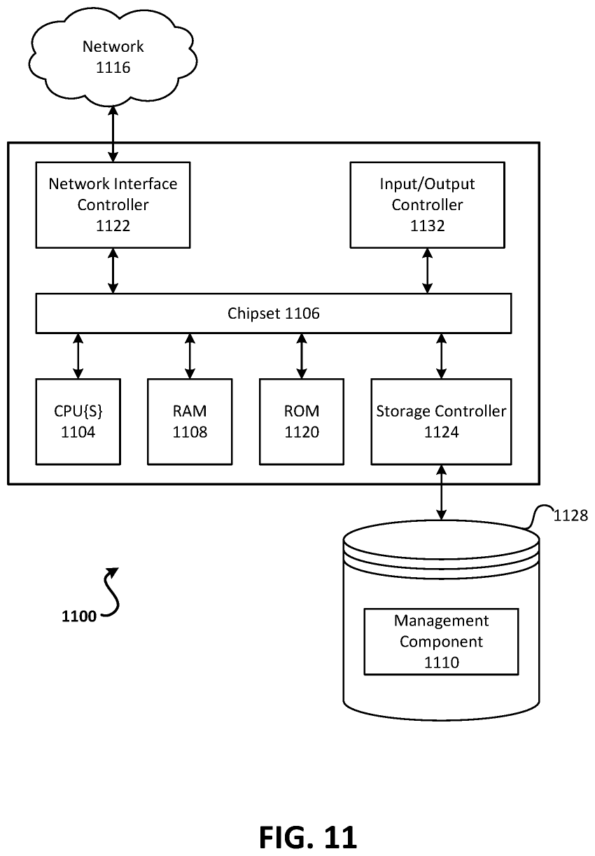

FIG. 11 depicts a computing device that may be used in various aspects, such as the servers, nodes, ledges, sweepers, modules, and/or devices depicted in FIG. 1-FIG. 7.

The computer architecture shown in FIG. 11 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1-FIG. 10.

The computing device 1100 may include a baseboard, or “motherboard,” which is a printed circuit board to which a multitude of components or devices may be connected by way of a system bus or other electrical communication paths. One or more central processing units (CPUs) 1104 may operate in conjunction with a chipset 1106. The CPU(s) 1104 may be standard programmable processors that perform arithmetic and logical operations necessary for the operation of the computing device 1100.

The CPU(s) 1104 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1104 may be augmented with or replaced by other processing units, such as GPU(s) 1105. The GPU(s) 1105 may comprise processing units specialized for but not necessarily limited to highly parallel computations, such as graphics and other visualization-related processing.

A chipset 1106 may provide an interface between the CPU(s) 1104 and the remainder of the components and devices on the baseboard. The chipset 1106 may provide an interface to a random access memory (RAM) 1108 used as the main memory in the computing device 1100. The chipset 1106 may further provide an interface to a computer-readable storage medium, such as a read-only memory (ROM) 1120 or non-volatile RAM (NVRAM) (not shown), for storing basic routines that may help to start up the computing device 1100 and to transfer information between the various components and devices. ROM 1120 or NVRAM may also store other software components necessary for the operation of the computing device 1100 in accordance with the aspects described herein.

The computing device 1100 may operate in a networked environment using logical connections to remote computing nodes and computer systems through local area network (LAN) 1116. The chipset 1106 may include functionality for providing network connectivity through a network interface controller (NIC) 1122, such as a gigabit Ethernet adapter. A NIC 1122 may be capable of connecting the computing device 1100 to other computing nodes over a network 1116. It should be appreciated that multiple NICs 1122 may be present in the computing device 1100, connecting the computing device to other types of networks and remote computer systems.

The computing device 1100 may be connected to a mass storage device 1128 that provides non-volatile storage for the computer. The mass storage device 1128 may store system programs, application programs, other program modules, and data, which have been described in greater detail herein. The mass storage device 1128 may be connected to the computing device 1100 through a storage controller 1124 connected to the chipset 1106. The mass storage device 1128 may consist of one or more physical storage units. A storage controller 1124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1100 may store data on a mass storage device 1128 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1128 is characterized as primary or secondary storage and the like.

For example, the computing device 1100 may store information to the mass storage device 1128 by issuing instructions through a storage controller 1124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1100 may further read information from the mass storage device 1128 by detecting the physical states or characteristics of one or more particular locations within the physical storage units.

In addition to the mass storage device 1128 described above, the computing device 1100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1100.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1128 depicted in FIG. 11, may store an operating system utilized to control the operation of the computing device 1100. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1128 may store other system or application programs and data utilized by the computing device 1100.

The mass storage device 1128 or other computer-readable storage media may also be encoded with computer-executable instructions, which, when loaded into the computing device 1100, transforms the computing device from a general-purpose computing system into a special-purpose computer capable of implementing the aspects described herein. These computer-executable instructions transform the computing device 1100 by specifying how the CPU(s) 1104 transition between states, as described above. The computing device 1100 may have access to computer-readable storage media storing computer-executable instructions, which, when executed by the computing device 1100, may perform the methods described in relation to FIGS. 1-10.

A computing device, such as the computing device 1100 depicted in FIG. 11, may also include an input/output controller 1132 for receiving and processing input from a number of input devices, such as a keyboard, a mouse, a touchpad, a touch screen, an electronic stylus, or other type of input device. Similarly, an input/output controller 1132 may provide output to a display, such as a computer monitor, a flat-panel display, a digital projector, a printer, a plotter, or other type of output device. It will be appreciated that the computing device 1100 may not include all of the components shown in FIG. 11, may include other components that are not explicitly shown in FIG. 11, or may utilize an architecture completely different than that shown in FIG. 11.

As described herein, a computing device may be a physical computing device, such as the computing device 1100 of FIG. 11. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be sent as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. The present invention may be practiced with other computer system configurations.

While the present disclosure has been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure.

Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, from a first device, data indicative of a first ledger associated with an account, wherein the first ledger comprises a first version of a distributed ledger associated with the account;
determining, based on the data indicative of the first ledger, a condition associated with the first ledger;
sending, based on the condition and to a second device associated with the account, a request for a second ledger, wherein the second ledger comprises a second version of the distributed ledger associated with the account;
receiving, based on the request, at least a portion of the second ledger;
determining, based on applying consensus rules to the first ledger and the second ledger, that one of the first ledger or the second ledger is an approved ledger; and
sending data indicative of the approved ledger.

2. The method of claim 1, wherein the condition comprises one or more of an error condition, a validation failure, a failure state, or a condition associated with failing a validation process, and wherein the condition is based on a determination that a data block of the first ledger has been added, removed, or modified.

3. The method of claim 1, wherein sending the request for the second ledger comprises determining a plurality of devices associated with the account and sending, to the plurality of devices, requests for corresponding versions of the distributed ledger stored by the plurality of devices.

4. The method of claim 1, wherein the first ledger is stored by the first device, and wherein the first device is associated with the account, and wherein the second ledger is stored by the second device.

5. The method of claim 1, wherein the distributed ledger comprises a plurality of transactions stored in corresponding data blocks, wherein each data block comprises only one transaction of the plurality of transactions.

6. The method of claim 1, wherein a master version of the distributed ledger is stored by a service platform comprising one or more computing devices configured to add transactions to the distributed ledger.

7. The method of claim 1, wherein at least one of a plurality of devices associated with the account comprises a version of the distributed ledger that has less than all data blocks stored on a master version of the distributed ledger.

8. A method comprising:
sending, to a first device, data associated with adding a transaction to a distributed ledger associated with an account;
receiving, from the first device and based on the data associated with adding the transaction, a condition associated with the distributed ledger;
sending, to a second device and based on the condition, data associated with determining an approved ledger, wherein the approved ledger comprises an approved version of the distributed ledger determined based on applying a consensus algorithm to a plurality of versions of the distributed ledger received from one or more devices associated with the account;
receiving, from the second device, data indicative of the approved ledger; and
sending, to the first device, data associated with adding the transaction to the approved ledger.

9. The method of claim 8, wherein the condition comprises one or more of an error condition, a validation failure, a failure state, or a condition associated with failing a validation process, and wherein the condition is based on a determination that a data block of at least one of the plurality of versions of the distributed ledger has been added, removed, or modified.

10. The method of claim 8, wherein the second device is configured to determine the one or more devices associated with the account and send, to the one or more devices associated with the account, requests for corresponding versions of the distributed ledger stored by the one or more devices associated with the account.

11. The method of claim 8, wherein the distributed ledger comprises a first ledger stored by a first computing device associated with the account and a second ledger stored by a second computing device associated with the account.

12. The method of claim 8, wherein the distributed ledger comprises a plurality of transactions stored in corresponding data blocks, wherein each data block comprises only one transaction of the plurality of transactions.

13. The method of claim 8, wherein a master version of the distributed ledger is stored by a service platform comprising a plurality of devices configured to add transactions to the distributed ledger.

14. The method of claim 13, wherein at least one of the one or more devices associated with the account comprises a version of the plurality of versions of the distributed ledger that has less than all data blocks stored on the master version of the distributed ledger.

15. A method comprising:
receiving data associated with adding a transaction to a distributed ledger associated with an account;
determining, based on the data associated with adding the transaction, a condition associated with the distributed ledger;
sending a message indicative of the condition;
receiving, based on the condition, data indicative of an approved ledger, wherein the approved ledger comprises an approved version of the distributed ledger determined based on applying a consensus algorithm to a plurality of versions of the distributed ledger received from one or more devices associated with the account; and
causing an update of the approved ledger with data indicative of the transaction.

16. The method of claim 15, wherein the condition comprises one or more of an error condition, a validation failure, a failure state, or a condition associated with failing a validation process, and wherein determining the condition comprises determining that a data block of at least one of the plurality of versions of the distributed ledger has been added, removed, or modified.

17. The method of claim 15, wherein the plurality of versions of the distributed ledger comprise a first version stored by a first device associated with the account and a second version stored by a second device associated with the account.

18. The method of claim 15, wherein the distributed ledger comprises a plurality of transactions stored in corresponding data blocks, wherein each data block comprises only one transaction of the plurality of transactions.

19. The method of claim 15, wherein a master version of the distributed ledger is stored by a service platform comprising a plurality of devices configured to add transactions to the distributed ledger.

20. The method of claim 19, wherein at least one of the one or more devices associated with the account comprises a version of the distributed ledger that has less than all data blocks stored on the master version of the distributed ledger.
